(19) United States
(12) Patent Application Publication
(10) Pub. No.: US 2015/0373071 A1
(43) Pub. Date: Dec. 24, 2015

(54) ON-DEMAND HELPER OPERATOR FOR A STREAMING APPLICATION

(71) Applicant: International Business Machines Corporation, Armonk, NY (US)

(72) Inventors: Bin Cao, Rochester, MN (US); Brian R. Muras, Rochester, MN (US); Jingdong Sun, Rochester, MN (US)

(21) Appl. No.: 14/308,993

(22) Filed: Jun. 19, 2014

(51) Int. Cl. H04L 29/06; H04L 12/26; G06F 11/34; H04L 12/24

(52) U.S. Cl. CPC H04L 65/4084; H04L 41/24; H04L 43/16; G06F 11/3495

(57) ABSTRACT

A streams manager creates one or more helper operators when a streaming application is initially deployed. As the streaming application runs, the streams manager monitors performance of the streaming application. When a bottleneck is detected, the streams manager automatically adjusts a helper operator to help the operator experiencing the bottleneck, thereby dynamically improving performance of the streaming application. Helper operators can be dynamically created and destroyed by the streams manager as needed, and can be deployed to virtual machines in a cloud.

### BACKGROUND

1. Technical Field

This disclosure generally relates to streaming applications, and more specifically relates to enhancing performance of a streaming application using helper operators.

2. Background Art

Streaming applications are known in the art, and typically include multiple operators coupled together in a flow graph that process streaming data in near real-time. An operator typically takes in streaming data in the form of data tuples, operates on the tuples in some fashion, and outputs the processed tuples to the next operator. Streaming applications are becoming more common due to the high performance that can be achieved from near real-time processing of streaming data.

Many streaming applications require significant computer resources, such as processors and memory, to provide the desired near real-time processing of data. However, the workload of a streaming application can vary greatly over time. Allocating on a permanent basis computer resources to a streaming application that would assure the streaming application would always function as desired (i.e., during peak demand) would mean many of those resources would sit idle when the streaming application is processing a workload significantly less than its maximum. Furthermore, what constitutes peak demand at one point in time can be exceeded as the usage of the streaming application increases. For a dedicated system that runs a streaming application, an increase in demand may require a corresponding increase in hardware resources to meet that demand.

In stream computing, continuous streams of data flow into a streaming application that performs some type of analysis using that data. Streaming data must be processed as it is produced; thus stream computing can be characterized as real-time analysis of data-in-motion (as opposed to data-at-rest, i.e., stored data). A challenge in stream computing is the ability for an application to ingest and analyze very high volumes of data at a rate that “keeps up” with its data sources. A streaming application must perform at a very high level in some scenarios, with the ability to ingest, analyze, and correlate hundreds of thousands or millions of data tuples per second.

Because of this major performance challenge, streaming applications very often need to be deployed to distributed, multi-node environments to get enough processing resources required to perform at the required high levels. InfoSphere Streams product by the IBM Corporation is one example of a distributed stream computing platform. InfoSphere Streams is the industry leader in streaming infrastructure, and achieves this by providing an almost unlimited scale-out approach to stream computing.

One of the primary factors in how well a streaming application can perform is how its flow graph is mapped to the distributed, multi-node environment that it will run in. Developers or administrators can control the mapping in a product like InfoSphere Streams, or the InfoSphere Streams runtime can be given the responsibility of performing the initial scheduling of the flow graph onto the available resources. But once an application is running, this mapping may need to change, either because of a non-optimal initial scheduling or because data rates or other factors affecting the application might vary.

### BRIEF SUMMARY

A streams manager creates one or more helper operators when a streaming application is initially deployed. As the streaming application runs, the streams manager monitors performance of the streaming application. When a bottleneck is detected, the streams manager automatically adjusts a helper operator to help the operator experiencing the bottleneck, thereby dynamically improving performance of the streaming application. Helper operators can be dynamically created and destroyed by the streams manager as needed, and can be deployed to virtual machines in a cloud.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a cloud computing node;

FIG. 2 is a block diagram of a cloud computing environment;

FIG. 3 is a block diagram of abstraction model layers;

FIG. 4 is a block diagram showing some features of a cloud manager;

FIG. 5 is a block diagram showing some features of a streams manager;

FIG. 6 is a flow diagram of a method for a streams manager to deploy a flow graph with one or more helper operators;

FIG. 7 is a flow diagram of a first method for using helper operators to alleviate bottlenecks in a flow graph;

FIG. 8 is a flow diagram of a second method for using helper operators to alleviate bottlenecks in a flow graph;

FIG. 9 is a block diagram of a sample streaming application deployed with two helper operators;

FIG. 10 is a block diagram of the sample streaming application in FIG. 9 with one of the helper operators adjusted to help operator F; and

FIG. 11 is a high level code snippet showing one specific implementation of a helper operator.

### DETAILED DESCRIPTION

The disclosure and claims herein relate to a streams manager that creates one or more helper operators when a streaming application is initially deployed. As the streaming application runs, the streams manager monitors performance of the streaming application. When a bottleneck is detected, the streams manager automatically adjusts a helper operator to help the operator experiencing the bottleneck, thereby dynamically improving performance of the streaming application. Helper operators can be dynamically created and destroyed by the streams manager as needed, and can be deployed to virtual machines in a cloud.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

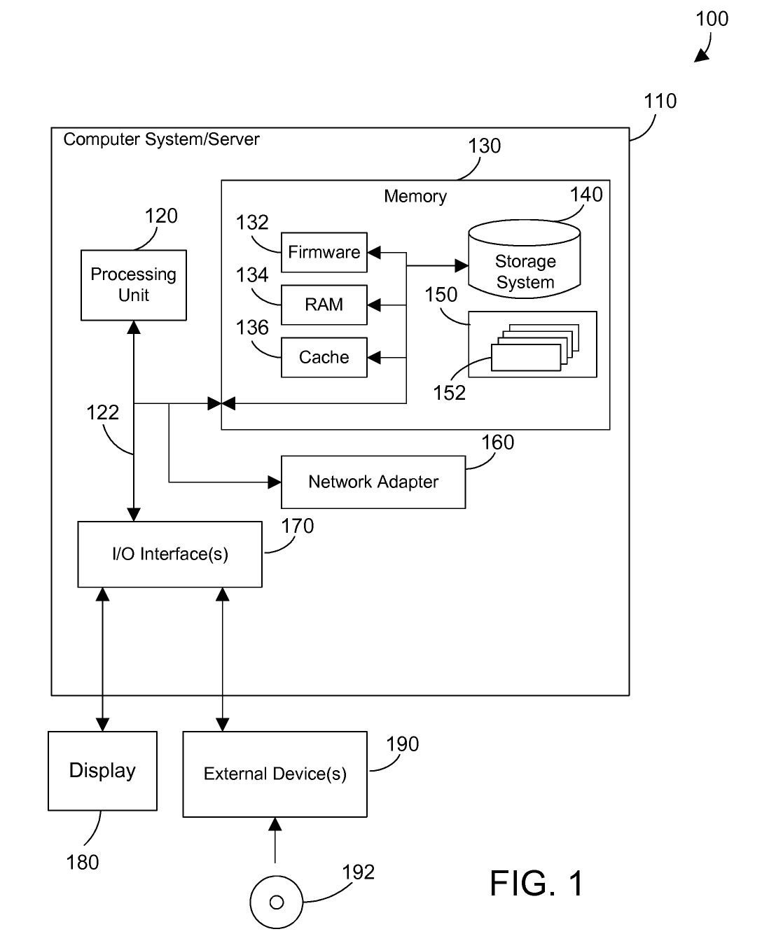

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, tablet computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processing unit 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media. An example of removable media is shown in FIG. 1 to include a Digital Video Disc (DVD) 192.

System memory 130 can include computer system readable media in the form of volatile or non-volatile memory, such as firmware 132. Firmware 132 provides an interface to the hardware of computer system/server 110. System memory 130 can also include computer system readable media in the form of volatile memory, such as random access memory (RAM) 134 and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, Redundant Array of Independent Disk (RAID) systems, tape drives, data archival storage systems, etc.

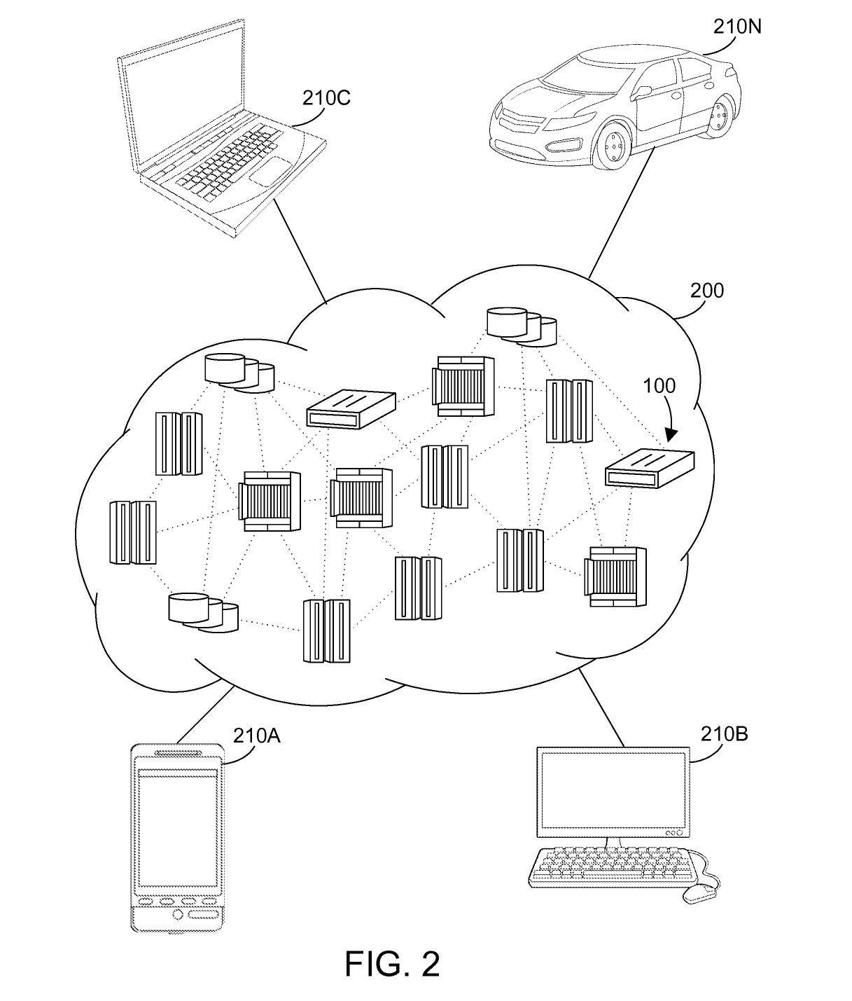

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

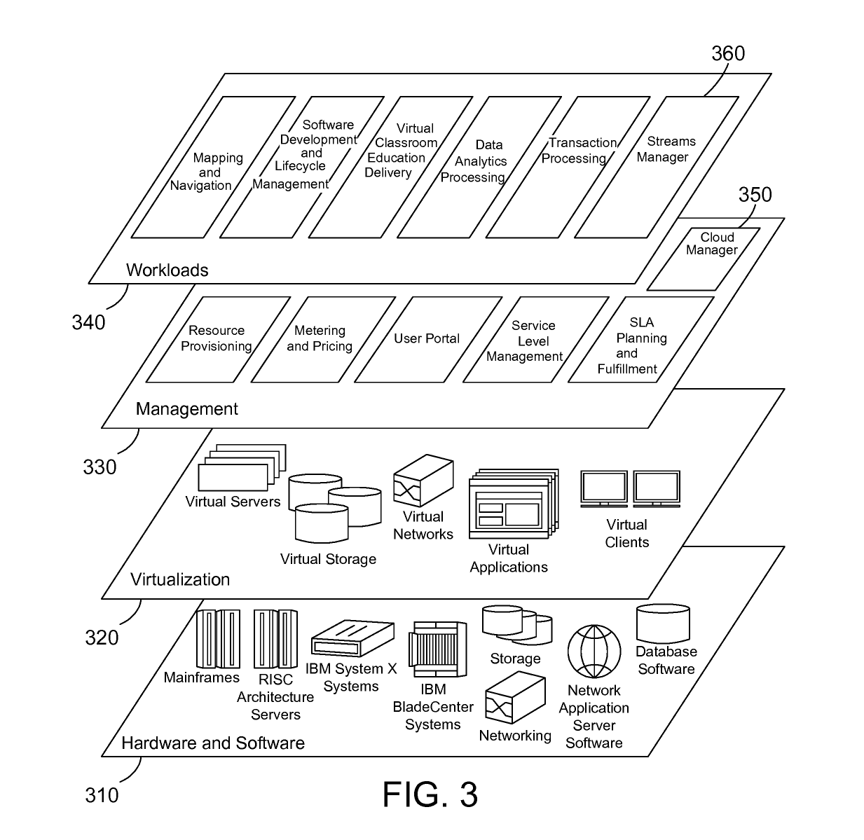

Referring now to FIG. 3, a set of functional abstraction layers provided by cloud computing environment 200 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes, in one example IBM System z systems; RISC (Reduced Instruction Set Computer) architecture based servers, in one example IBM System p systems; IBM System x systems; IBM BladeCenter systems; storage devices; networks and networking components. Examples of software components include network application server software, in one example IBM WebSphere® application server software; and database software, in one example IBM DB2® database software. IBM, System z, System p, System x, BladeCenter, WebSphere, and DB2 are trademarks of International Business Machines Corporation registered in many jurisdictions worldwide.

Virtualization layer 320 provides an abstraction layer from which the following examples of virtual entities may be provided: virtual servers; virtual storage; virtual networks, including virtual private networks; virtual applications and operating systems; and virtual clients.

In one example, management layer 330 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 350 is representative of a cloud manager as described in more detail below. While the cloud manager 350 is shown in FIG. 3 to reside in the management layer 330, cloud manager 350 can span all of the levels shown in FIG. 3, as discussed in detail below.

Workloads layer 340 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a streams manager 360, as discussed in more detail below.

As will be appreciated by one skilled in the art, aspects of this disclosure may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

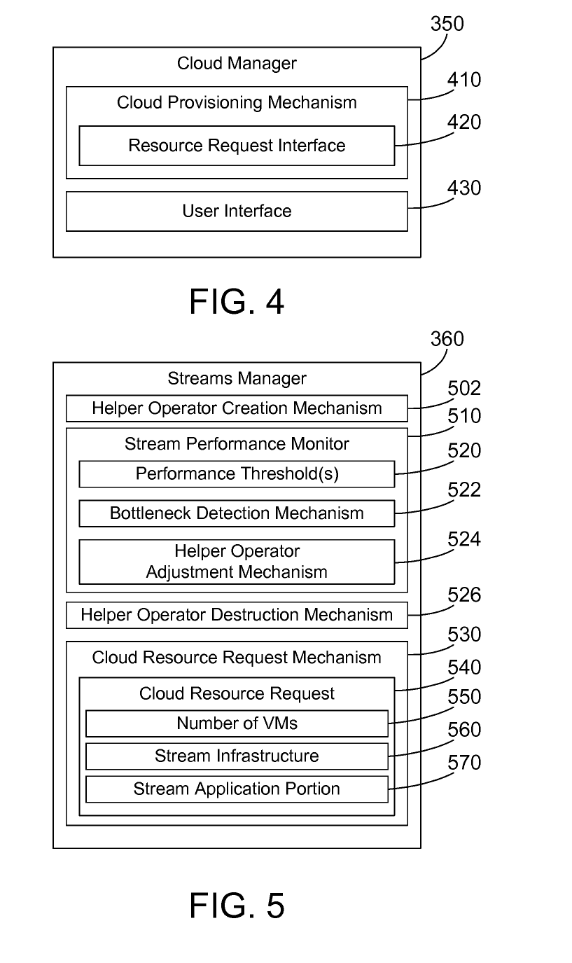

FIG. 4 shows one suitable example of the cloud manager 350 shown in FIG. 3. The cloud manager 350 includes a cloud provisioning mechanism 410 that includes a resource request interface 420. The resource request interface 420 allows a software entity, such as the streams manager 360, to request virtual machines from the cloud manager 350 without human intervention. The cloud manager 350 also includes a user interface 430 that allows a user to interact with the cloud manager to perform any suitable function, including provisioning of VMs, destruction of VMs, performance analysis of the cloud, etc. The difference between the resource request interface 420 and the user interface 430 is a user must manually use the user interface 430 to perform functions specified by the user, while the resource request interface 420 may be used by a software entity to request provisioning of cloud resources by the cloud mechanism 350 without input from a human user. Of course, cloud manager 350 could include many other features and functions known in the art that are not shown in FIG. 4.

FIG. 5 shows one suitable example of the streams manager 360 shown in FIG. 3. The streams manager 360 is software that manages one or more streaming applications, including creating operators and data flow connections between operators in a flow graph that represents a streaming application. The streams manager 360 includes a helper operator creation mechanism 502 that creates one or more helper operators when a streaming application is initially deployed. Creation of helper objects could be done when some aspect or function is shared between operators such as: a schema, a tuple format, a function or method, such as a static method in C++, a shared input or output stream, a physical or virtual computing environment such as a shared Linux virtual machine or virtual network, virtual storage, etc. Thus, when the definition of the helper operator allows some aspect of at least two helped operators to share some environment, definition or implementation, then an advantage can be gained by creating the helper object. When helper operators are created, their inputs and outputs are initially disconnected from the flow graph that represents the streaming application. In addition to creating one or more helper operators when an application is initially deployed, the helper operator creation mechanism 502 can also create helper operators dynamically as the streaming application executes, as needed. Note that helper operators can be created on a dedicated system running a streaming application, or could be created in a cloud by the streams manager formulating an appropriate cloud resource request 540, as discussed in more detail below, then deploying the helper operator to a virtual machine in a cloud.

The streams manager 360 includes a streams performance monitor 510 that preferably includes one or more performance thresholds 520. Performance thresholds 520 can include static thresholds, such as percentage used of current capacity, and can also include any suitable heuristic for measuring performance of a streaming application as a whole or for measuring performance of one or more operators in a streaming application. Performance thresholds 520 may include different thresholds and metrics at the operator level, at the level of a group of operators, and/or at the level of the overall performance of the streaming application. The stream performance monitor preferably monitors performance of one or more operators in the flow graph for the streaming application. A bottleneck detection mechanism 522 detects when an operator is not processing tuples as quickly as the tuples are arriving, which means the operator is a bottleneck. The bottleneck detection mechanism 522 can determine an operator is a bottleneck in any suitable way. For example, the bottleneck detection mechanism 522 could monitor conditions in operators, and detect a bottleneck in an operator based on one or more conditions internal to the operator. In another example, the bottleneck detection mechanism 522 could compare performance of operators to one or more of the performance thresholds 520. In yet another example, each operator could monitor its own performance, and when an operator detects it has become a bottleneck, the operator notifies the bottleneck detection mechanism 522. Of course, other ways of detecting bottlenecks are also possible. The disclosure and claims herein expressly extend to any suitable way to determine an operator has become a bottleneck.

When the bottleneck detection mechanism 522 detects an operator in the streaming application is a bottleneck, a helper operator adjustment mechanism 524 adjusts one or more helper operators to help the operator that is a bottleneck. For example, a helper operator could be adjusted to process tuples in parallel with the bottleneck operator, thereby increasing the rate of processing incoming tuples. The helper operator adjustment mechanism 524 can adjust helper operators multiple times, essentially re-tasking the helper operators dynamically to help different operators that have become bottlenecks at different points in time.

The streams manager 360 also includes a cloud resource request mechanism 530 that allows the streams manager to request one or more virtual machines (VMs) from the cloud manager 350. The cloud resource request mechanism 530 assembles a cloud resource request 540, which can include information such as a number of VMs to provision 550, stream infrastructure needed in each VM 560, and a stream application portion 570 for each VM. Once the cloud resource request 540 is formulated, the streams manager 360 submits the cloud resource request 540 to a cloud manager via the resource request interface 420 as shown in FIG. 4. In response, the cloud manager 350 provisions one or more VMs with the specified streams infrastructure and stream application portion, which the streams manager can then use to deploy a portion of the streaming application. One of the benefits of a cloud environment is the ability to have many helper operators deployed on unused cloud resources, which makes the helper operators dynamically available in a very short time to improve performance of the streaming application.

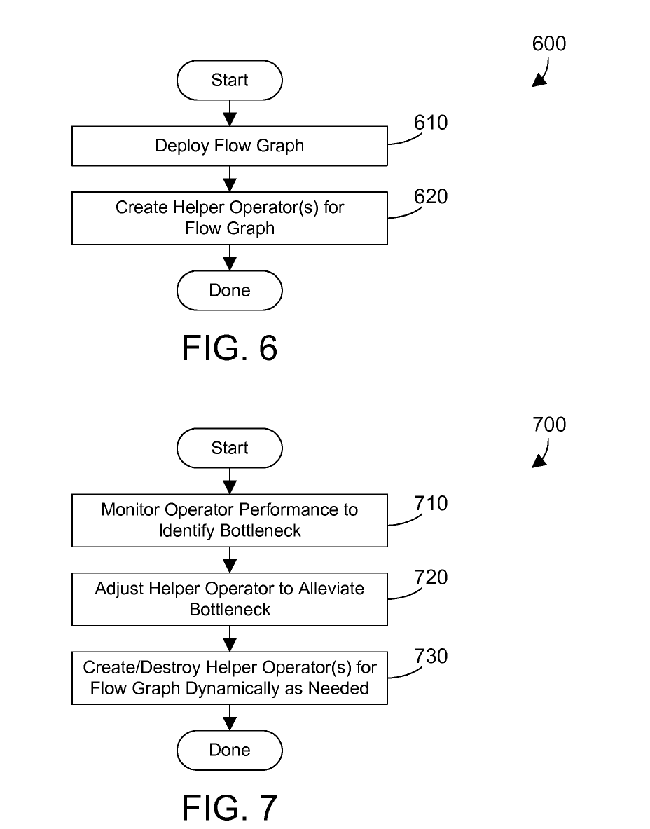

Referring to FIG. 6, a method 600 is preferably performed by the streams manager 360 shown in FIGS. 3 and 5. The flow graph for a streaming application is deployed (step 610). This includes creating operators and connecting the operators together in the desired flow graph. One or more helper operators for the flow graph are also deployed (step 620). Each helper operator is an operator that initially has no input or output connections, but may include logic for one or more of the operators in the flow graph. The logic in the helper operator can vary. For example, a helper operator could include logic for all operators in the flow graph so it can be readily adjusted to help any operator in the flow graph. In the alternative, a helper operator could include logic for a single operator, or for any subset of operators in the flow graph. For example, the flow graph could be divided into five different sections, and five helper operators could be deployed that each includes the logic for all operators in one of the sections of the flow graph. In another example, the helper operator may include functionality to load specific logic when needed. Thus, the helper operator may not initially include any logic specific to any of the operators in the flow graph, but could include logic such as a plugin that could be loaded real-time when the helper object is needed to customize or adjust the helper operator to perform the function of one or more operators in the flow graph. Thus, when needed, a helper operator can be adjusted by the streams manager to help an operator that has a bottleneck, as discussed in more detail below.

FIG. 7 shows a method 700 that is preferably performed by the streams manager 360 shown in FIGS. 3 and 5. The performance of one or more operators in the flow graph is monitored (step 710). When a bottleneck operator is found, a helper operator is adjusted to help the bottleneck operator to alleviate the bottleneck (step 720). One specific example is for a helper operator to be placed in parallel with the operator that has the bottleneck so the number of tuples being processed increases. In addition, the streams manager can create and destroy helper operators dynamically for the flow graph as needed as the streaming application executes (step 730). In this manner the streams operator can dynamically tune the performance of the streaming application using helper operators as tuple rates change over time.

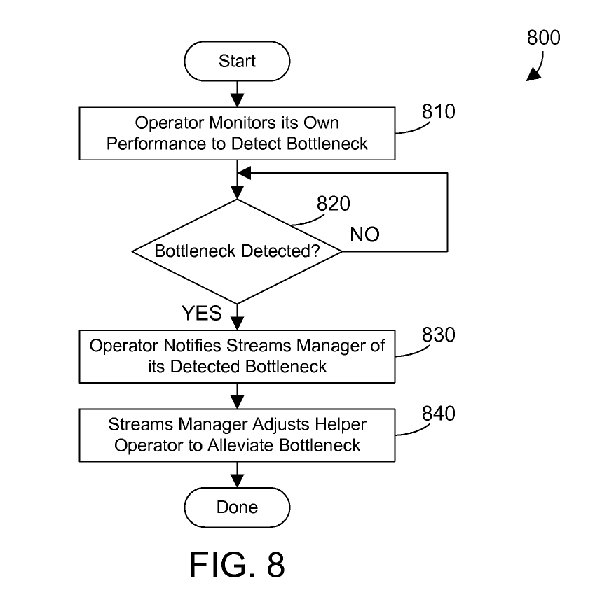

In addition to the streams manager monitoring performance of operators to find a bottleneck, the operators themselves can include logic that can notify the streams operator when the operator detects it has a bottleneck. Referring to FIG. 8, an operator monitors its own performance to detect a bottleneck (step 810). When no bottleneck is detected (step 820=NO), method 800 loops back to step 820. When a bottleneck is detected (step 820=YES), the operator notifies the streams manager of its detected bottleneck (step 830). In response, the streams manager adjusts the helper operator to alleviate the bottleneck (step 840). Placing a helper operator in parallel with the operator that detected it has a bottleneck is one suitable way to adjust the helper operator to alleviate the bottleneck in step 840.

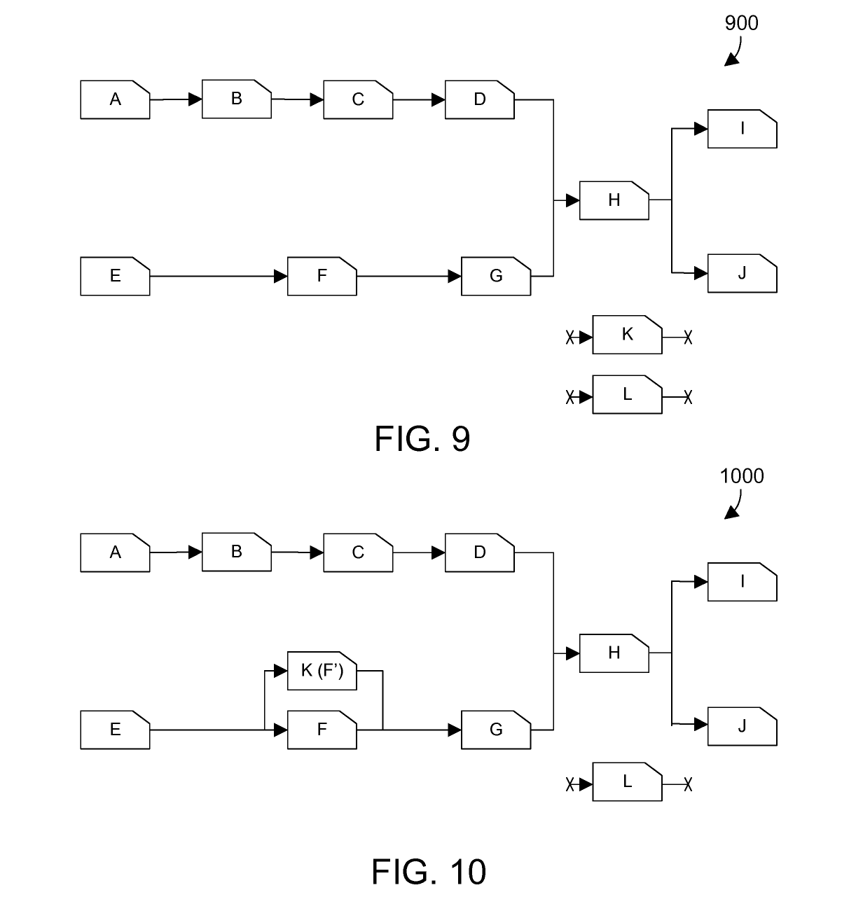

A simple example is provided in FIGS. 9 and 10 to illustrate some of the concepts discussed above. Referring to FIG. 9, a streaming application 900 includes operators A, B, C, D, E, F, G, H, I and J as shown. Operator A originates a stream of tuples, which is processed by operator B, which outputs tuples. The tuples from operator B are processed by operator C, which outputs tuples to operator D, which processes the tuples and outputs its tuples to operator H. In similar fashion, operator E originates a stream of tuples, which is processed by operator F, which outputs tuples that are processed by operator G, which outputs tuples to operator H. Note that operator H receives tuples from both operator D and operator G. Operator H processes the tuples it receives from operator D and from operator G, and outputs its tuples to operators I and J. The streams manager at the time of deploying the flow graph 900 also creates two helper operators K and L shown in FIG. 9, which have their inputs and outputs initially disconnected, but include logic for implementing one or more operators in the flow graph. For this example, we assume helper operator K includes logic for operator F. Note that operator K could also include logic for other operators in the flow graph.

The streaming application 900 could run on a dedicated system, such as a computer system/server 100 shown in FIG. 1. In the alternative, one or more operators could be deployed to virtual machines in a private or public cloud. Of course, all of the operators could be deployed to a cloud. In a system where one or more operators are deployed to a cloud, the number of helper operators can increase or decrease based on available resources in the cloud without impacting the performance of the streaming application.

The operators in the streaming application 900 are monitored to determine whether any of the operators become a bottleneck. The term “bottleneck” is a colloquial term that denotes that the rate of liquid flowing out of a bottle is limited by the size of the neck of the bottle. Contrast this, for example, with pouring liquid from a bucket, where there is no bottleneck, and therefore the liquid can pour out all at once. The term “bottleneck” is very commonly used in engineering realms to denote something that restricts or limits something else. In the context of a streaming application, an operator can become a “bottleneck” or can experience a “bottleneck” when the operator processes incoming data tuples at a rate less than the rate of receiving the incoming data tuples. In addition, the disclosure and claims extend the concept of a “bottleneck” to include any conditions in a computer system that can be used to deploy a helper operator. Thus, a bottleneck as used herein can include not only current bottlenecks, but impending bottlenecks before they happen. For example, a threshold could be set for CPU usage, buffer usage, network utilization, etc. that could trigger the need for a helper operator, even when no operator is in the state of processing incoming data tuples at a rate less than the rate of receiving the incoming data tuples. A bottleneck as used herein expressly extends to any conditions that can trigger the deployment of a helper operator, whether those conditions relate to performance of physical hardware, performance of virtual machines, performance of individual operators, or performance of a group of operators.

We assume the performance of operators is monitored by the streams manager. Referring again to FIG. 7, the streams operator monitors operator performance to identify a bottleneck (step 710). For the example in FIG. 9, we assume the streams manager detects that operator F becomes a bottleneck. In response, the streams manager adjusts the helper operator to alleviate the bottleneck (step 720). As shown in FIG. 10, this can be done by connecting operator K in parallel with operator F as shown. Because operator K includes the logic for operator F, it becomes a parallel operator F′ that at least partially alleviates the bottleneck experienced by operator F by processing some of the incoming tuples in parallel with operator F.

Now we consider the same example in FIG. 9 when the operators monitor themselves for bottleneck conditions, as shown in FIG. 8. Operator F monitors its own performance to detect a bottleneck (step 810). As long as no bottleneck is detected (step 820=NO), method 800 loops back to step 820 and continues until a bottleneck is detected (step 820=YES). The operator notifies the streams manager of its detected bottleneck (step 830). The streams manager then adjusts a helper operator to alleviate the bottleneck (step 840). Once again, this can be done as shown in FIG. 10 by adjusting the helper operator K to process tuples in parallel with operator F.

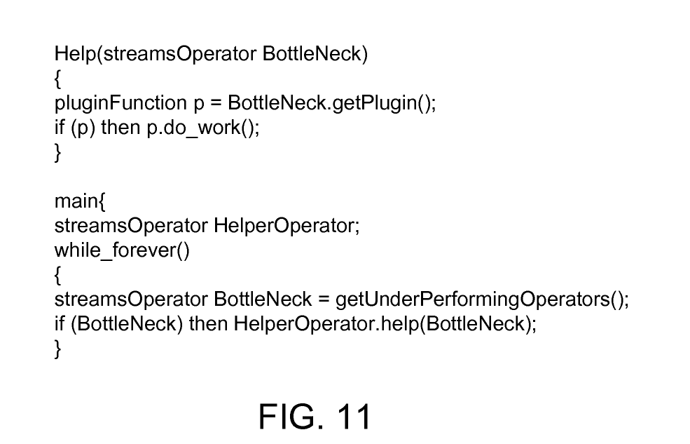

Referring to FIG. 11, a high level code snippet shows one specific implementation for a helper operator. Helper operators can be created as toolkits. Each helper operator can be flexible enough to be adjusted dynamically to perform the logic of multiple operators in the flow graph. In the code snippet in FIG. 11, the helper object loops (while_forever) in real time and listens for notifications, such as those provided in step 830 in FIG. 8. The notifications are delivered via a non-null stream operator Bottleneck object. If a bottleneck is detected, then a module is executed to perform assistance (.help method) to the operator. In this case, a plugin is retrieved which contains specific code to help the operator. The specific code segment is defined in the do_work( ) method. For example, the do_work( ) could retrieve tuples, and process them with the same or similar functions that are defined in the bottleneck operator. The do_work( ) method would take a portion of the bottleneck tuples from the bottleneck operator, and operate on them. For example if the bottleneck operator was parsing strings in tuples, then the helper operator would have specific code in its plugin to parse the string with that same tuple definition. This specific code would be executed via the do_work( ) method.

In another embodiment, the helper operator could dynamically check various conditions in the flow graph, such as detecting an underperforming operator by detecting a high utilization level, detecting backed up buffers, detecting tuples being dropped because an operator is too busy, etc. In response, the helper operator could be adjusted to provide needed help to one or more operators in the flow graph.

While the simple example in FIGS. 9 and 10 shows one helper operator K that implements the function of operator F that is adjusted to help operator F, this is not to be construed as limiting of the concepts herein. For example, the bottleneck detection mechanism 522 in FIG. 5 could detect different levels of severity for a bottleneck, such as mild, moderate and severe. Any suitable strategy could be implemented for helper operators. For example, a mild bottleneck in an operator could result in adjusting a single helper operator to be in parallel with the operator. A moderate bottleneck could result in adjusting two helper operators both to be in parallel with the operator. A severe bottleneck could result in adjusting three helper operators all to be in parallel with the operator. Of course, these principles could be further scaled as needed. For example, two helper operators could be used for a mild bottleneck, five helper operators could be used for a moderate bottleneck, and ten helper operators could be used for a severe bottleneck. In addition, while deploying a helper operator in parallel with an operator that has a bottleneck has been disclosed in the specific examples herein, a helper operator can be deployed strategically at any location in the flow graph that could improve a bottleneck condition. For example, if an operator in the flow graph that the streams manager does not manage becomes a bottleneck, such as when part of the flow graph is pre-existing code that provides tuples to operators managed by the streams manager, the streams manager could detect the bottleneck, then adjust one or more helper operators to help downstream operators that the streams manage does control that are negatively affected by the detected bottleneck. The disclosure and claims herein expressly extend to adjusting any suitable number of helper operators to help any suitable number of operators that are experiencing a bottleneck at any suitable location or locations in the flow graph.

Note also a helper operator can be adjusted to be re-tasked to help in a different way. For example, if operator F ceases to be a bottleneck and no longer needs help, the helper operator K could be further adjusted. For example, let's assume the helper operator K includes logic for all operators A, B, C, D, E, F, G, H, I and J in FIG. 10. Let's further assume that after operator F no longer needs help, operator D needs help. In response, the streams manager could further adjust operator K so that it no longer processes tuples in parallel with operator K using its internal logic for operator K, and instead processes tuples in parallel with operator D using its internal logic for operator D. Helper operators can thus be deployed dynamically where needed to enhance the performance of a streaming application. This concept can scale up to a very large scale, where a streaming application in a flow graph with thousands of operators could have hundreds of helper operators available to be adjusted as needed to enhance the performance of the streaming application.

The streaming application disclosed and claimed herein provides an incredibly powerful and flexible way to improve the performance of a streaming application. By deploying helper operators when the flow graph is initially deployed, these helper operators can be used dynamically on-demand as needed to help operators that are experiencing a bottleneck. Helper operators can also be dynamically created and destroyed as needed as the streaming application executes.

The principles discussed above have been discussed in the context of a streaming application that has one or more operators deployed to a private or public cloud. However, these same principles apply equally as well to a dedicated system running a streaming application. The disclosure and claims herein expressly extend to helper operators in both cloud-based and non-cloud environments.

The disclosure and claims herein relate to a streams manager that creates one or more helper operators when a streaming application is initially deployed. As the streaming application runs, the streams manager monitors performance of the streaming application. When a bottleneck is detected, the streams manager automatically adjusts a helper operator to help the operator experiencing the bottleneck, thereby dynamically improving performance of the streaming application. Helper operators can be dynamically created and destroyed by the streams manager as needed, and can be deployed to virtual machines in a cloud.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a streaming application residing in the memory and executed by the at least one processor, the streaming application comprising a flow graph that includes a plurality of operators that process a plurality of data tuples; and
a streams manager residing in the memory and executed by the at least one processor, the streams manager deploying the streaming application to the memory and deploying at least one helper operator that has an input and an output that initially are disconnected, the streams manager monitoring performance of at least one of the plurality of operators in the streaming application, and when one of the at least one operators in the streaming application becomes a bottleneck, the streams manager adjusts the at least one helper operator by connecting the input and the output of the helper operator to the flow graph to alleviate the bottleneck in the one operator.

2. The apparatus of claim 1 wherein the one operator becomes a bottleneck by processing incoming data tuples at a rate less than a rate of receiving the incoming data tuples.

3. The apparatus of claim 1 wherein the streams manager detects when the one operator becomes a bottleneck.

4. The apparatus of claim 3 wherein the streams manager detects when the one operator becomes a bottleneck by monitoring at least one condition in the one operator.

5. The apparatus of claim 3 wherein the streams manager detects when the one operator becomes a bottleneck by comparing performance of the one operator with at least one threshold.

6. The apparatus of claim 3 wherein the one operator detects when the one operator becomes a bottleneck and sends a notification to the streams manager, wherein the streams manager detects when the one operator becomes a bottleneck by receiving the notification from the one operator.

7. The apparatus of claim 1 wherein the streams manager monitors the performance of the at least one of the plurality of operators by comparing current performance of the at least one of the plurality of operators to at least one defined performance threshold.

8. The apparatus of claim 1 wherein the helper operator implements logic for the one operator and processes data tuples in parallel with the one operator in the flow graph after the streams manager adjusts the at least one helper operator.

9. The apparatus of claim 1 wherein the streams manager dynamically creates and destroys a plurality of helper operators as needed during execution of the streaming application.

10-19. (canceled)
